(19) United States
(12) Patent Application Publication
(10) Pub. No.: US 2026/0270633 A1
(43) Pub. Date: Sep. 10, 2026

(54) Method of fitting a hearing device to a user, and fitting system

(71) Applicant: SONOVA AG, Staefa (CH)

(72) Inventors: Charlotte Vercammen, London (GB); Olaf Strelcyk, Cincinnati, OH (US); Nicola Hildebrand, Uster (CH)

(21) Appl. No.: 19/071,419

(22) Filed: Mar. 5, 2025

(51) Int. Cl. H04R 25/00

(52) U.S. Cl. CPC H04R 25/70; H04R 25/356; H04R 25/507; H04R 2225/39

(57) ABSTRACT

The disclosure relates to a method of fitting a hearing device to a user, the method comprising obtaining an auditory input dataset; determining an estimate of an auditory threshold based on the auditory input dataset; determining first and second parameter settings each representative of a different amplification characteristic of the hearing device; and initiating an outputting of an audio signal by an audio output unit included in the hearing device when consecutively applying the first and second parameter settings. The invention further relates to a system for fitting a hearing device.

### TECHNICAL FIELD

The disclosure relates to a method of fitting a hearing device to a user. The disclosure further relates to a system for fitting a hearing device.

### BACKGROUND

Hearing devices may be used to improve the hearing capability or communication capability of a user, for instance by compensating a hearing loss of a hearing-impaired user, in which case the hearing device is commonly referred to as a hearing instrument such as a hearing aid, or hearing prosthesis. A hearing device may also be used to output sound based on an audio signal which may be communicated by a wire or wirelessly to the hearing device. A hearing device may also be used to reproduce a sound in a user's ear canal detected by an input transducer such as a microphone or a microphone array. The reproduced sound may be amplified to account for a hearing loss, such as in a hearing instrument, or may be output without accounting for a hearing loss, for instance to provide for a faithful reproduction of detected ambient sound and/or to add audio features of an augmented reality in the reproduced ambient sound, such as in a hearable. A hearing device may also provide for a situational enhancement of an acoustic scene, e.g. beamforming and/or active noise cancelling (ANC), with or without amplification of the reproduced sound. A hearing device may also be implemented as a hearing protection device, such as an earplug, configured to protect the user's hearing. Different types of hearing devices configured to be be worn at an ear include earbuds, earphones, hearables, and hearing instruments such as receiver-in-the-canal (RIC) hearing aids, behind-the-ear (BTE) hearing aids, in-the-ear (ITE) hearing aids, invisible-in-the-canal (IIC) hearing aids, completely-in-the-canal (CIC) hearing aids, cochlear implant systems configured to provide electrical stimulation representative of audio content to a user, a bimodal hearing system configured to provide both amplification and electrical stimulation representative of audio content to a user, or any other suitable hearing prostheses. A hearing system comprising two hearing devices configured to be worn at different ears of the user is sometimes also referred to as a binaural hearing device. A hearing system may also comprise a hearing device, e.g., a single monaural hearing device or a binaural hearing device, and a user device, e.g., a smartphone and/or a smartwatch, communicatively coupled to the hearing device.

Hearing devices are often employed in conjunction with communication devices, such as smartphones or tablets, for instance when listening to sound data processed by the communication device and/or during a phone conversation operated by the communication device. More recently, communication devices have been integrated with hearing devices such that the hearing devices at least partially comprise the functionality of those communication devices. A system may comprise, for instance, a hearing device and a communication device.

Hearing impairment affects a substantial portion of the global population, diminishing quality of life and communication ability. Hearing instruments are critical devices for managing hearing loss, with their effectiveness largely dependent on accurate fitting to the user's unique audiometric profile. Traditionally, this fitting process requires an audiometric assessment conducted by a healthcare professional (HCP), followed by the application of a recognized prescriptive fitting rule to adjust amplification settings based on the user's audiogram. For example, the NAL-NL2 (National Acoustic Laboratories' Non-Linear version 2) prescription is a widely recognized standard, designed to maximize speech intelligibility and ensure comfortable listening levels for those with hearing impairment.

With the recent availability of over-the-counter (OTC) hearing aids, there is an increasing demand for solutions that enable users to self-fit their devices without the involvement of a healthcare professional. This self-fitting process involves measuring hearing thresholds directly via the hearing aid or through an accompanying mobile application, generating an audiogram, and applying an appropriate prescription rule to personalize the amplification settings.

U.S. Patent Application Publication 2022/0218236 A1 describes a system for self-administered hearing evaluation that aims to overcome common issues with traditional and at-home hearing tests. The system uses a combination of auditory measurements and questionnaire responses to develop a personalized hearing profile for the user. Unlike conventional approaches, the system utilizes distinct auditory tests for each ear, employing different acoustic stimuli such as frequencies or types of sounds to accurately assess hearing issues. The system architecture includes an input module that communicates with an estimation module, which applies a predictive model to the inputted auditory measurement data to estimate an auditory threshold of the user depending on frequency, which is commonly referred to as an audiogram.

However, current self-fitting technologies often fall short in terms of accuracy, ease of use, and adaptability to dynamic listening environments, leading to suboptimal user satisfaction and inconsistent hearing improvement. Furthermore, traditional fitting methods, e.g., based on a clinical and/or a self-administered hearing evaluation, often fail to account for individual listening preferences and real-world auditory environments. As a result, users may experience suboptimal performance, leading to frequent adjustments and dissatisfaction.

Paired comparison techniques, also referred to as A-B comparisons, offer an effective way to refine hearing aid settings based on user preferences. By presenting the users with two parameter settings of the hearing device and allowing them to choose the preferred option, a more precise and individualized tuning of amplification, frequency response and other parameters can be achieved. However, a vast number of different parameter settings from which the user can choose may overwhelm the user and the finding of the optimum parameters may still be not accomplishable.

### SUMMARY

It is a feature of the present disclosure to avoid at least one of the above mentioned disadvantages and to provide for an improvement of current fitting methods and systems, e.g., in terms of user satisfaction, precision, time, and/or complexity of the fitting procedure. It is a further feature to allow a user to self-fit a hearing device, e.g. after purchasing an over-the-counter (OTC) device, or after an initial fitting of the hearing device performed by a health care professional (HCP), in a user-friendly way which also accounts for the user's individual preferences and/or hearing characteristics.

Accordingly, the present disclosure proposes a method comprising
obtaining, in an auditory input operation, an auditory input dataset representative of one or more hearing characteristics of the user;
determining, in an auditory threshold estimation operation, an estimate of a frequency-dependent auditory threshold based on the auditory input dataset;
determining, in a parameter setting operation, first and second parameter settings each representative of a different amplification characteristic of the hearing device so as to compensate for a hearing impairment of the user;
initiating, in an audio outputting operation, an outputting of an audio signal by an audio output unit included in the hearing device when consecutively applying the first and second parameter settings of the hearing device so as to allow the user a comparison in between;
determining, in the auditory threshold estimation operation, a variability range of the estimate, the variability range defining a set of values in which the auditory threshold is variable relative to the estimate, wherein the variability range is determined based on an uncertainty metric representative of an uncertainty of the estimate, and wherein, in the parameter setting operation, the first and second parameter settings are determined such that the amplification characteristic of the hearing device is adjusted to the auditory threshold comprised within the variability range.

Independently, the present disclosure proposes a system for fitting a hearing device to a user, the system comprising a processor configured to perform the method. Independently, the present disclosure proposes a non-transitory computer-readable medium storing instructions that, when executed by a processor included in a system, cause the system to perform the method.

Subsequently, additional features of some implementations of the method and/or the system and/or the computer readable medium are described. Each of those features can be provided solely or in combination with at least another feature. The features can be correspondingly provided in some implementations of the method and/or the system and/or the computer readable medium.

In some implementations, by restricting a selection of the first and second parameter settings from a large number of possible parameter settings to the parameter settings accounting for an adjustment to the auditory threshold lying within the variability range, a complexity and/or time expenditure during the finding of the preferred hearing device settings can be effectively reduced. In some implementations, the determining of the variability range depending on the uncertainty metric can provide for an easy correction of inaccuracies in the fitting process, which may be reflected in the uncertainty metric, and/or provide for the possibility of a reduced accuracy during an initial fitting by offering the possibility of such an easy correction.

In some implementations, the uncertainty metric is representative of an uncertainty about an accuracy of the hearing characteristics represented in the auditory input dataset; and/or an uncertainty about an accuracy of the determining of the estimate based on the auditory input dataset and/or an uncertainty about a correction of the estimate required to account for suprathreshold hearing impairment. In some implementations, the uncertainty metric is representative of an expected deviation of the estimate from ground truth data regarded as an accurate representation of the auditory threshold; and/or a confidence whether the auditory threshold is correctly represented by the estimate output by a predictive model; and/or an expected correction of the estimate required to account for suprathreshold hearing impairment. In some examples, the expected deviation from ground truth data and/or the expected correction required to account for suprathreshold hearing impairment is based on historical data, e.g., one or more historical estimate datasets and/or one or more reference datasets, which may be collected in database. In some examples, the suprathreshold hearing impairment can be derived from a semantic user input and/or a suprathreshold measurement, which may be included in the auditory input dataset.

In some implementations, the estimate is provided as a prototype of the auditory threshold. The uncertainty metric may then be representative of whether the auditory threshold is correctly represented by the auditory threshold prototype. In some implementations, the estimate may be provided by a predictive model. The uncertainty metric may then be representative of whether the auditory threshold has been correctly predicted by the predictive model.

In some implementations, the set of values in which the auditory threshold is variable relative to the estimate comprises at least one interval having a size depending on a frequency of the auditory threshold; and/or at least one interval with a constant size at different frequencies of the auditory threshold; and/or a plurality of subsets of discrete values of the auditory threshold.

In some implementations, the estimate of the auditory threshold is representative of an estimate of a hearing impairment of the user. In some examples, the hearing impairment represented by the estimate may include a clinically measurable hearing loss (e.g., a mild, moderate, or severe hearing loss), and/or a suprathreshold hearing impairment (e.g., a very mild or hidden hearing loss). In some implementations, the estimate of the auditory threshold is representative of a threshold comparable to a normal-hearing reference and/or indicative of a deviation from the threshold of a normally hearing person. In some examples, the estimate is representative of an estimated audiogram as obtained in a clinical measurement, e.g., a pure-tone measurement of the auditory threshold. In some examples, the estimate may then be provided in units of dB HL. In some implementations, the estimate is representative of an effective auditory threshold in which a certain type for hearing impairment, e.g., a suprathreshold hearing impairment, may be accounted for. The effective auditory threshold may then be representative of an effective hearing impairment. For example, the estimate may be representative of an adaption of the auditory threshold to a suprathreshold hearing impairment. In some examples, the estimate may then be provided in units of dB.

In some implementations, the auditory input dataset comprises an auditory measurement dataset representative of a response of the user to one or more auditory stimuli presented to the user in an auditory measurement procedure; and/or a suprathreshold measurement dataset representative of a hearing assessment of the user conducted at sound levels above the user's hearing threshold; and/or a semantic input dataset representative of descriptive information about the user. In some examples, the suprathreshold measurement dataset comprises results of a speech recognition test and/or a temporal and frequency resolution test and/or an acoustic reflex test and/or a loudness growth measure. In some examples, the semantic input dataset comprises information relevant for a hearing impairment of the user, e.g., a suprathreshold hearing impairment, and/or demographic data, e.g., age, gender, etc., of the user. In some examples, the semantic input dataset comprises a questionnaire response dataset representative of a response of the user to one or more question items associated with the user. In some examples, the semantic input dataset comprises a text, e.g., in a written form and/or in the form of speech, in which the user may address a hearing problem.

In some implementations, the method further comprises providing, e.g., in a memory, a plurality of prototypes of the auditory threshold, wherein said determining of the estimate of the auditory threshold and/or said determining of the variability range comprises attributing the auditory input dataset to one or more of the auditory threshold prototypes. In some implementations, the auditory threshold prototypes each comprise one or more values of the auditory threshold which have been previously determined on an individual, e.g., the user or another individual. In some implementations, the auditory threshold prototypes each comprise a previously measured audiogram, e.g., a clinical audiogram. In some implementations, the auditory threshold prototypes are ground truth datasets.

In some implementations, the variability range is determined such that said set of values comprises two or more of the attributed prototypes. In some implementations, the uncertainty metric is representative of an uncertainty whether the auditory input dataset is correctly attributed to the prototype. In some implementations, the estimate is determined by selecting from one or more of the attributed prototypes depending on the uncertainty metric.

In some implementations, the attributing the auditory input dataset to the auditory threshold prototype comprises inputting the auditory input dataset in a model configured to output one or more of the auditory threshold prototypes attributed to the auditory input dataset, and the uncertainty metric associated with the respective attributed auditory threshold prototype and/or the variability range based on the uncertainty metric.

In some implementations, the determining of the estimate of the auditory threshold comprises inputting the auditory input dataset in a machine learning algorithm configured to predict the estimate of the auditory threshold, and a confidence measure indicative of a confidence of the prediction, wherein the uncertainty metric comprises the confidence measure.

In some implementations, the model comprises the machine learning algorithm. In some implementations, the machine learning algorithm has been trained with training data comprising one or more of the auditory threshold prototypes. In some implementations, the confidence measure is determined by Bayesian inference and/or by performing a probabilistic classification task.

In some implementations, the method further comprises providing, e.g., in a memory, a plurality of prototypes of the variability range, wherein said determining of the variability range comprises attributing the estimate of the auditory threshold to at least one of said variability range prototypes.

In some implementations, the method further comprises collecting, in a database, historical data associated with different individuals, wherein the historical data comprises a historical estimate dataset representative of an estimate of the auditory threshold of the respective individual; and a reference dataset representative of the auditory threshold of the respective individual which has been determined with a higher accuracy and/or lower uncertainty as compared to the historical estimate dataset; and determining a deviation measure representative of a deviation of the historical estimate dataset from the reference dataset for one or more of said individuals, wherein the uncertainty metric comprises the deviation measure.

In some implementations, the reference dataset is a ground truth dataset which is regarded as an accurate representation of the auditory threshold of the individual. In some implementations, the reference dataset is representative of a clinical audiogram, e.g., a clinical air-conduction audiogram. In some implementations, the historical estimate dataset has been previously determined in said auditory threshold estimation operation, In some implementations, the historical estimate dataset has been previously determined based on an historical auditory input dataset representative of one or more hearing characteristics of the individual.

In some implementations, the method further comprises determining one or more of the variability range prototypes based on the deviation measure.

In some implementations, the method further comprises collecting, in a database, historical data associated with different individuals, wherein the historical data comprises a historical estimate dataset representative of an estimate of the auditory threshold of the respective individual, wherein one or more of the of variability range prototypes are determined based on the historical dataset. In some implementations, the historical data further comprises a reference dataset representative of the auditory threshold of the respective individual which has been determined with a higher accuracy and/or lower uncertainty as compared to the historical estimate dataset, the method further comprising determining a deviation measure representative of a deviation of the historical estimate dataset from the reference dataset for one or more of said individuals, wherein the uncertainty metric comprises the deviation measure.

In some implementations, the method further comprises determining two or more candidate datasets representative of the auditory threshold of the user within the variability range, wherein the first and/or second parameter settings are determined from the candidate datasets by a predefined prescription rule. E.g., the prescription rule may comprise a NAL-NL2 and/or DSL prescription rule. In some implementations, the first and/or second parameter settings are determined from three or more candidate datasets in a round robin procedure; and/or in a selection based on an evolutionary algorithm, e.g., a genetic algorithm.

In some implementations, the method further comprises, receiving comparison result data indicative of which of the first and second parameter settings are preferred by the user, and, storing the preferred parameter settings in a memory of the hearing device.

In some implementations, the auditory threshold is frequency-dependent. In some implementations, the auditory threshold, e.g., frequency-dependent auditory threshold, is represented by an audiogram. In some implementations, the auditory threshold is represented by an effective hearing impairment.

### BRIEF DESCRIPTION OF THE DRAWINGS

Reference will now be made in detail to embodiments, examples of which are illustrated in the accompanying drawings. The drawings illustrate various embodiments and are a part of the specification. The illustrated embodiments are merely examples and do not limit the scope of the disclosure. Throughout the drawings, identical or similar reference numbers designate identical or similar elements. In the drawings:

FIGS. 1 and 2 schematically illustrate an exemplary system of fitting a hearing device;

FIG. 3 schematically illustrates an exemplary hearing device;

FIGS. 4-7 schematically illustrate exemplary configurations of the system illustrated in FIGS. 1 and 2;

FIG. 8 schematically illustrates an exemplary configuration for collecting historical data;

FIGS. 9-12 show exemplary graphs illustrating estimates of an auditory threshold and variability ranges of the auditory threshold relative to the estimates; and

FIGS. 13-15 illustrate exemplary methods of fitting a hearing device according to principles described herein.

### DETAILED DESCRIPTION OF THE DRAWINGS

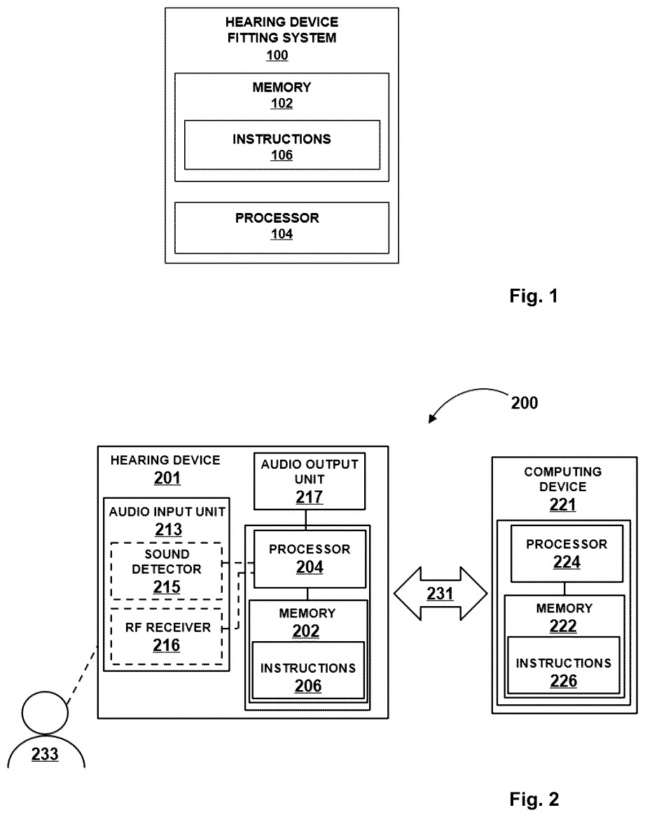

FIG. 1 illustrates an exemplary hearing device fitting system 100 that may be implemented according to principles described herein. As shown, system 100 may include, without limitation, a memory 102 and a processor 104 selectively and communicatively coupled to one another. Memory 102 and processor 104 may each include or be implemented by hardware and/or software components (e.g., processors, memories, communication interfaces, instructions stored in memory for execution by the processors, etc.). In some examples, memory 102 and/or processor 104 may be implemented by any suitable computing device. In other examples, memory 102 and/or processor 104 may be distributed between multiple devices and/or multiple locations as may serve a particular implementation.

Memory 102 may maintain (e.g., store) executable data used by processor 104 to perform any of the operations described herein. For example, memory 102 may maintain any of the datasets described herein. Memory 102 may also store instructions 106 that may be executed by processor 104 to perform any of the operations described herein (e.g., instructions to determine an estimate of an auditory threshold and/or a variability range of the estimate and/or to determine parameter settings of the hearing device). Instructions 106 may be implemented by any suitable application, software, code, and/or other executable data instance. Memory 102 may also maintain any other data received, generated, managed, used, and/or transmitted by processor 104. Memory 102 may be implemented by any suitable non-transitory computer-readable medium and/or non-transitory processor-readable medium, such as any combination of non-volatile storage media and/or volatile storage media.

Processor 104 may be configured to execute instructions 106 to perform various operations described herein as being performed by system 100. For example, system 100 (e.g., processor 104) may obtain an auditory measurement dataset, determine an estimate of an auditory threshold of the user based thereon, determine a variability range of the estimate, determine first and second parameter settings each representative of a different amplification characteristic of a hearing device, and initiate the hearing device to output am audio signal to the user when consecutively applying the first and second parameter settings so as to allow the user a comparison in between. These and other operations that may be performed by system 100 are described herein.

System 100 may be implemented in any suitable manner. In some examples, system 100 may be implemented as a hearing device. In some examples, system 100 may be implemented as a computing device configured to be communicatively coupled to a hearing device, e.g., a communication device such as a smartphone, tablet, personal computer and/or any other user device. In some examples, system 100 may be implemented as a hearing device and a computing device which may be communicatively coupled, e.g., via a cable, a network, a Bluetooth connection or other type of radio frequency (RF) radiation and/or the like.

To illustrate, FIG. 2 shows an exemplary implementation 200 in which system 100 may be provided. As shown in FIG. 2, implementation 200 includes a hearing device 201 that is associated with a user 233 and that is communicatively coupled to a computing device 221 by way of a data connection 231.

Hearing device 201 may be implemented by any type of hearing device configured to enable or enhance hearing or a listening experience of user 233 wearing hearing device 201. For example, hearing device 201 may be implemented by a hearing aid configured to provide an amplified version of audio content to a user, a sound processor included in a cochlear implant system configured to provide electrical stimulation representative of audio content to a user, a sound processor included in a bimodal hearing system configured to provide both amplification and electrical stimulation representative of audio content to a user, an over-the-counter (OTC) hearing device, or any other suitable hearing prosthesis, or an earbud or an earphone or any other hearable.

In certain examples, hearing device 201 may be implemented as part of a binaural hearing system. Such a binaural hearing system may include a first hearing device associated with a first ear of a user and a second hearing device associated with a second ear of a user. In such examples, the hearing devices may each be implemented by any type of hearing device configured to provide or enhance hearing to a user of a binaural hearing system. In some examples, the hearing devices in a binaural system may be of the same type. For example, the hearing devices may each be hearing aid devices. In certain alternative examples, the hearing devices may be of a different type. For example, a first hearing device may be a hearing aid and a second hearing device may be a sound processor included in a cochlear implant system.

Different types of hearing device 201 can also be distinguished by the position at which they are worn at the ear. Some hearing devices, such as behind-the-ear (BTE) hearing aids and receiver-in-the-canal (RIC) hearing aids, typically comprise an earpiece configured to be at least partially inserted into an ear canal of the ear, and an additional housing configured to be worn at a wearing position outside the ear canal, in particular behind the ear of the user. Some other hearing devices, as for instance earbuds, earphones, hearables, in-the-ear (ITE) hearing aids, invisible-in-the-canal (IIC) hearing aids, and completely-in-the-canal (CIC) hearing aids, commonly comprise such an earpiece to be worn at least partially inside the ear canal without an additional housing for wearing at the different ear position.

Hearing device 201 may include a memory 202 and a processor 204 selectively and communicatively coupled to one another. Memory 202 and processor 204 may each include or be implemented by hardware and/or software components (e.g., processors, memories, communication interfaces, instructions stored in memory for execution by the processors, etc.). Memory 202 may maintain (e.g., store) executable data used by processor 204 to perform any of the operations associated with hearing device 200. For example, memory 202 may store instructions 206 that may be executed by processor 204 to perform any of the operations associated with hearing device 202 assisting a user in hearing and/or any of the operations described herein, which may include instructions 106. Memory 202 may also maintain any data received, generated, managed, used, and/or transmitted by processor 204. For example, memory 202 may maintain any suitable data associated with a hearing loss profile of a user, input sound classifications, sound processing patterns, machine learning algorithms, and/or hearing device function data.

Processor 204 may be configured to perform any suitable processing operation associated with hearing device 201. For example, when hearing device 201 is implemented by a hearing instrument, such processing operations may include monitoring ambient sound and/or presenting amplified sound to user 233 via an audio output unit 217, e.g., an in-ear receiver. Processor 204 may be implemented by any suitable combination of hardware and software. In certain examples, processor 212 may include one or more deep neural network (“DNN”) chips configured to perform any suitable machine learning operation such as described herein.

As shown in FIG. 2, hearing device 201 may further include an audio input unit 213 and audio output unit 217 communicatively coupled to processor 204. Audio input unit 213 is configured to obtain an input audio signal. Processor 204 is configured to provide for a processing of the input audio signal to obtain an output audio signal. Audio output unit 217 is configured to output the output audio signal so as to stimulate the user's hearing by outputting the output audio signal. Audio output unit 217 may be implemented by any suitable audio output device configured to output the output audio signal to the user. For example, audio output unit 117 may be implemented as a receiver of a hearing aid, a loudspeaker of an earbud, or an output electrode of a cochlear implant.

In some implementations, as illustrated, audio input unit 213 may comprise a sound detector 215 configured to detect sound in an ambient environment of the user and to provide an ambient audio signal representative of the detected sound. The input audio signal, which is received by processor 204, may then at least partially be based on the ambient audio signal. In some examples, sound detector 215 may be implemented as a microphone and/or a microphone array.

In some implementations, as illustrated, audio input unit 213 may comprise a radio receiver 216 configured to receive a radio audio signal from a remote audio source via radio frequency (RF) radiation. The input audio signal, which is received by processor 204, may then at least partially be based on the radio audio signal. Radio receiver 216 may be configured for wireless data reception of the radio audio signal. For instance, the radio audio signal may be received in accordance with a Bluetooth™ protocol and/or by any other type of RF communication. In some examples, the remote audio source may be a remote microphone, e.g., a table microphone or a clip-on microphone, configured to detect sound at a remote location and transmit the radio audio signal indicative of the detected sound to radio receiver 216. In some examples, the remote audio source may be a streaming source configured for streaming the radio audio signal to radio receiver 216. In some examples, the remote audio source may be a communication device, e.g., a portable device such as a smartphone, tablet, smartwatch and/or the like, or a computing device such as a personal computer, configured for data transmission of the radio audio signal to radio receiver 216.

Hearing device 201 may include further components as may serve a particular implementation. E.g., hearing device 201 may further include a user interface and/or a communication port for data transmission and/or an ear-canal microphone and/or other sensors such as a motion sensor and/or a physiological sensor.

FIG. 3 illustrates an exemplary implementation of hearing device 201 as a RIC hearing aid 261. RIC hearing aid 261 comprises a BTE part 270 configured to be worn at an ear at a wearing position behind the ear, and an ITE part 280 configured to be worn at the ear at a wearing position at least partially inside an ear canal of the ear. BTE part 270 comprises a BTE housing 271 configured to be worn behind the ear. BTE housing 271 accommodates a processing unit 264, which may comprise processor 204 and memory 202, communicatively coupled to sound detector 215 and radio receiver 216. BTE part 220 further includes a battery 277 as a power source. ITE part 280 is an earpiece comprising an ITE housing 281 at least partially insertable into the ear canal. ITE housing 281 accommodates audio output unit 217 implemented as a receiver. BTE part 270 and ITE part 280 are interconnected by a cable 274. Processing unit 264 is communicatively coupled to audio output unit 217 of ITE part 280 via cable 274 and cable connectors 272, 273 provided at BTE housing 271 and ITE housing 281.

Referring again to FIG. 2, computing device 221 may include or be implemented by any suitable hardware and/or software components (e.g., processors, memories, communication interfaces, instructions stored in memory for execution by the processors, etc.) and may include any combination of computing units as may serve a particular implementation. As illustrated, computing device 221 may include, without limitation, a memory 222 and a processor 224 selectively and communicatively coupled to one another. For example, memory 222 may store instructions 226 that may be executed by processor 224 to perform any of the operations described herein, such as, e.g., instructions 106. In some examples, computing device 221 may be implemented by a mobile phone, a mobile computing device, a tablet computer, a laptop computer, a desktop computer, a server or server system, and/or any other suitable computing device and/or system that may be configured to be communicatively coupled to the hearing device. In such examples, computing device 221 may be configured to perform any suitable operations such as those described herein to facilitate a fitting of hearing device 201 to the individual needs of user 233.

Data connection 231 may be implemented as a wired and/or wireless connection, e.g., via radio frequency (RF) transmitters, optical transmitters, or a cable. In some examples, data connection 231 may be implemented via a network. The network may include, but is not limited to, one or more wireless networks (Wi-Fi networks), wireless communication networks, mobile telephone networks (e.g., cellular telephone networks), mobile phone data networks, broadband networks, narrowband networks, the Internet, local area networks, wide area networks, and any other networks capable of carrying data and/or communications signals between hearing device 201 and computing device 221. In certain examples, data connection 231 may be implemented by a Bluetooth protocol (e.g., Bluetooth Classic, Bluetooth Low Energy (“LE”), etc.) and/or any other suitable communication protocol to facilitate communications between hearing device 201 and computing device 221. Communications between hearing device 201, computing device 221, and any other device/system may be transported using any one of the above-listed data connections, e.g., networks, or any combination or sub-combination thereof.

System 100 may be implemented by computing device 221 or hearing device 201. Alternatively, system 100 may be distributed across computing device 206 and hearing device 201, or distributed across computing device 221, hearing device 201, and/or any other suitable computing system/device. To this end, memory 102 of system 100 may be implemented by one or more of memories 202, 222. Processor 104 of system 100 may be implemented by one or more of processors 204, 224, or a plurality of processors 204, 224 forming a distributed processing system.

User 233 may be any individual user of a hearing device. Hearing device 201 may be configured to be optimized for user 233 by fitting hearing device 201 in a manner customized for user 233. Fitting hearing device 201 may include setting parameters of hearing device 202 for individualized hearing needs of user 204. In some examples, hearing device 202 may be fit by a health care professional (HCP). In other examples, system 100 may be configured to provide for, e.g., facilitate, a self-fitting of hearing device 201, e.g., by user 233 and/or another individual such as a significant other of user 233. To illustrate, in some examples, computing device 221 may be implemented as a user device provided at a location of the user, which can thus be operated by the user, e.g., in a self-fitting procedure performed by the user himself or a significant other. In some examples, computing device 221 may be implemented as a remote device provided at a location remote from the user, which may then be operated by a person at the remote location, e.g., in a remote-fitting procedure which may be performed by an HCP when the user is at a different location. In some examples, computing device 221 may also be employed for a local fitting which may performed by an HCP when the user is at the same location.

For instance, system 100 (e.g., computing device 221 and/or hearing device 201) may receive input from user 233 based on which system 100 may determine values for parameter settings of hearing device 202 to provide optimal sound quality to user 204. In some examples, the fitting process may include obtaining an auditory input dataset representative of one or more hearing characteristics of the user. The auditory input dataset may include an auditory measurement dataset acquired in an auditory measurement procedure performed on user 233. The auditory measurement dataset may be representative of an auditory measurement procedure previously performed on user 233, e.g., by the user himself in a self-administered manner or with the assistance of another person such as an HCP. In some examples, the auditory measurement dataset may include measurement values indicative of a reaction of the user to one or more auditory stimuli to which the user is subjected, e.g., depending on a frequency of the auditory stimuli, and/or any other user feedback and/or hearing evaluation allowing to estimate an audiogram or a pseudo audiogram. Based on the auditory input dataset, system 100 may determine an estimate of a frequency-dependent auditory threshold of the user, which may be implemented as an audiogram. System 100 may then determine the parameter settings (e.g., gain levels, etc.) of the hearing device based on the estimated audiogram, e.g., by applying a predefined prescription rule such as an NAL-NL2 or DSL prescription rule.

However, fitting the parameter settings of hearing device 202 based on the auditory input dataset and/or the estimated audiogram may yield parameters which are at least not fully optimized for user 233. To illustrate, uncertainties in the auditory input dataset may arise in the auditory measurement procedure, which may be referred to as measurement errors. Other uncertainties can arise during estimating the auditory threshold (e.g., during determining the estimated audiogram) based on the input dataset, which may be referred to as estimation errors. Estimating the threshold may be uncertain, e.g., due to a probabilistic nature of an estimation algorithm which may be capable to determine the threshold values only with a certain likelihood or within a certain confidence interval. Further uncertainties may arise due to a suprathreshold hearing impairment of the user, which may be referred to as subclinical errors. To illustrate, hearing impairment may manifest itself in a clinically measurable hearing loss, which may be verified, e.g., in the form of auditory thresholds deviating from a normal-hearing reference. Other types of hearing impairment, such as a suprathreshold hearing impairment (e.g., a hidden hearing loss or a very mild hearing loss), may be clinically hidden or not easily quantifiable in a clinical measurement and may therefore be referred to as subclinical hearing loss. Some indications of a suprathreshold hearing impairment may be derived from a semantic user input, e.g., a questionnaire or other user text, which may point to hearing problems of the user even if the auditory thresholds do not deviate from a normal-hearing reference. Some indications of a suprathreshold hearing impairment may also be derived from a dedicated suprathreshold measurement, as disclosed, e.g., in U.S. Pat. Nos. 11,962,980 B2 and 11,490,216 B2. Further uncertainties may arise due to subjective hearing preferences of the user, which may be referred to as preference errors. Those uncertainties (e.g., measurement errors and/or estimation errors and/or subclinical errors and/or preference errors) are then reproduced in parameter settings of hearing device 202 which are not optimal for user 233.

To overcome this problem, paired comparisons (which may also be referred to as A-B comparisons) can be employed in which auditory stimuli are presented to the user when consecutively applying different parameter settings (e.g., two or more parameter settings) of hearing device 202. This allows the user to compare the amplification characteristics of hearing device 202 during application of the different parameter settings and choose optimal settings based on the comparison. Nevertheless, the different parameter settings, from which the user can choose from, should also be optimized in a certain way. Otherwise, the comparison procedure could overwhelm the user in various ways, e.g., in terms of a complexity or time expenditure, and the finding of the optimum parameters may still be not accomplishable.

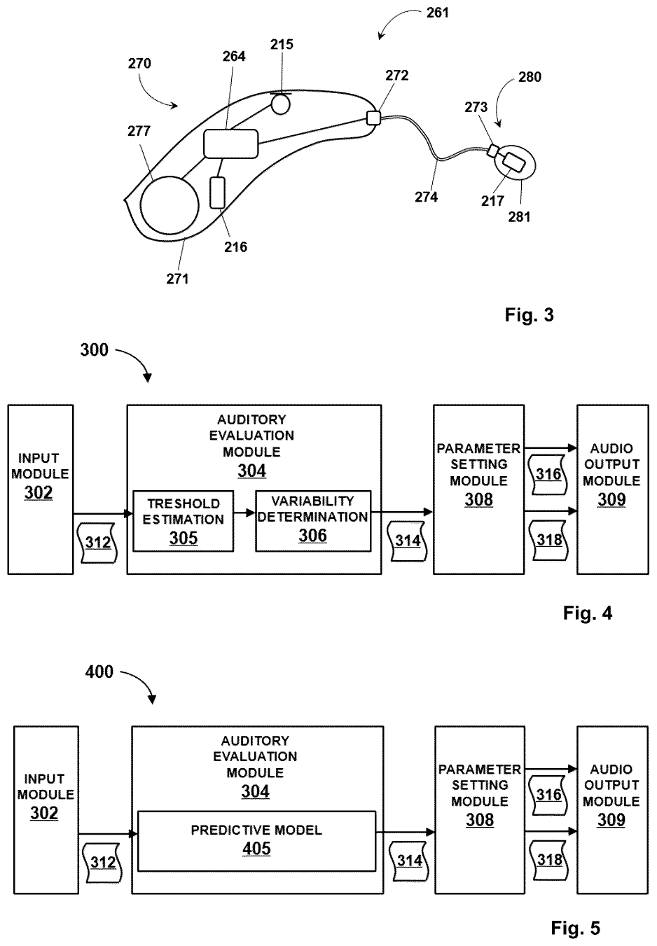

FIG. 4 illustrates an exemplary configuration 300 that includes an input module 302, an auditory evaluation module 304, a parameter setting module 308, and an audio output module 309 in communication with another. Modules 302, 304, 308, 309 may include any suitable combination of hardware and/or software and may be implemented by any of the systems described herein (e.g., by any of systems 100, 200 in any of the various implementations described above).

Input module 302 is configured to obtain an auditory input dataset 312 representative of one or more hearing characteristics of the user. In some examples, input module 302 may be configured to obtain auditory input dataset 312 via a data connection with an external device. E.g., auditory input dataset 312 may have been previously acquired with the aid of an auditory measurement device. In some examples, input module 302 may be configured to obtain auditory input dataset 312 in an interaction with the user, e.g., in an auditory measurement procedure and/or in a suprathreshold measurement procedure and/or by querying a semantic input dataset from the user, e.g., by addressing a questionnaire to the user.

In some examples, auditory input dataset 312 comprises an auditory measurement dataset representative of a response (e.g., any kind of reaction) of the user to one or more auditory stimuli presented to the user in an auditory measurement procedure. In some examples, input module 302 may be configured to obtain, e.g., acquire, the auditory measurement dataset by performing the auditory measurement test procedure. For example, input module 302 may direct an acoustic signal generator (e.g., a component within or connected to computing device 221) to present one or more auditory stimuli to the user. Input module 302 may then measure one or more responses by the user to the one or more auditory stimuli.

In some examples, the auditory measurements can be free-field, monaural, diotic, dichotic, and/or any other type of measurements involving auditory stimuli delivered to the user via one or more sound transducers, such as loudspeakers, headphones, or earphones. The auditory measurements can be threshold and supra-threshold measurements. These can be (but are not limited to) measurements of detection thresholds, most comfortable levels, and/or uncomfortable levels for various sounds such as tones, narrowband noises, speech, and/or bird song. Furthermore, the auditory measurements can be measurements of tone-in-noise detection thresholds, measurements of intelligibility of speech tokens such as phonemes, digits, or words in quiet or in various backgrounds such as interfering noises or talkers.

In some examples, the auditory measurement procedure can be constant-stimuli, a method of adjustment, a method of limits, or adaptive such as an adaptive staircase procedure. The response can be given consciously or unconsciously. For example, the response can be given by manual input, by verbal response, and/or in any other suitable manner. A response may, for example, be recorded by video of the user such as pupillometry, by recording changes in electrical potential on the user's scalp (e.g., EEG), by recording the user's skin conductance, by brain sensors or other biosensors such as transdermal microneedles, optical sensors, and/or mechanical sensors (e.g., accelerometers). The measurement procedure may be performed by the user himself, e.g., in a self-test procedure, and/or with the assistance of another person, e.g., a health care professional (HCP) or a significant other.

The auditory measurement procedure may be performed with respect to one or both ears of the user. In some examples, the auditory measurement dataset may comprise a first auditory measurement dataset acquired in a first auditory measurement procedure performed on a first ear of the user, and a second auditory measurement dataset acquired in a second auditory measurement procedure performed on his second ear. For example, in the first auditory measurement procedure, input module 302 may be configured to present one or more auditory stimuli having one or more attributes included in a first acoustic stimulus set to the first ear of the user. Accordingly, in the second auditory measurement procedure, input module 302 may be configured to present one or more auditory stimuli having one or more attributes included in a second acoustic stimulus set to the second ear of the user. In some examples, one or more attributes of the auditory stimuli included in the first and second acoustic stimulus set are different from one another. In some examples, one or more attributes of the auditory stimuli included in the first and second acoustic stimulus set are equal. For example, an acoustic stimulus attribute set may include attributes representative of discrete frequencies of the auditory stimuli, spectral characteristics of the auditory stimuli, temporal characteristics of the auditory stimuli, perceptive attributes of the auditory stimuli, etc.

In some examples, auditory input dataset 312 comprises a suprathreshold measurement dataset which may be representative of a hearing assessment of the user conducted at sound levels above the user's hearing threshold. In some examples, the suprathreshold measurement dataset comprises results of a speech recognition test and/or a temporal and frequency resolution test and/or an acoustic reflex test and/or a loudness growth measure.

In some examples, auditory input dataset 312 comprises a semantic input dataset representative of descriptive information about the user. In some examples, the semantic input dataset may comprise information relevant for a hearing impairment of the user, e.g., a suprathreshold hearing impairment, and/or demographic data, e.g., age, gender, etc., of the user. In some examples, the semantic input dataset may comprise a questionnaire response dataset representative of a response of the user to one or more question items associated with the user. Input module 302 may acquire the semantic input dataset in any suitable manner. For example, input module 302 may present, by way of a graphical user interface (e.g., a graphical user interface displayed by computing system 202), one or more questions items (or simply “questions”). The user may provide user input representative of one or more responses to the questions by, for example, interacting with the graphical user interface. Additionally or alternatively, input module 302 may audibly present the one or more questions, and the user input may be provided verbally by the user.

Auditory evaluation module 304 is configured to determine, based on auditory input dataset 312 received from input module 302, an estimate of a frequency-dependent auditory threshold (e.g., an audiogram) of the user, and a variability range of the estimate defining a set of values in which the auditory threshold is variable relative to the estimate. To this end, auditory evaluation module 304 comprises a threshold estimation module 305 and a variability determination module 306. Information indicative of the variability range of the estimate may be included in auditory evaluation data 314, which may be provided by auditory evaluation module 304. In some examples, as illustrated, the estimate of the auditory threshold may be determined by threshold estimation module 305 and the variability range of the estimate may be determined by variability determination module 306 in a sequence. In other examples, the estimate of the auditory threshold may be determined by threshold estimation module 305 and the variability range of the estimate may be determined by variability determination module 306 independent from in parallel to one another, e.g., each based on auditory input dataset 312.

Threshold estimation module 305 can be configured to determine the estimate based on auditory input dataset 312 in any suitable manner. In some examples, determining the estimate may include a regression and/or a classification of auditory input dataset 312. In some examples, the estimate may be determined in a predictive model, e.g., a machine learning model (ML). Some examples are described in US 2022/0218236 A1 herewith included by reference, e.g., a multivariate regression model (see paragraphs 60 to 63) and/or a ML model (see paragraphs 64 to 70), which may be based on Bayesian inference and/or a k-means clustering algorithm (see paragraphs 71 to 74). In some examples, a ML model may be based on Gaussian Processes (GPs) to model a probabilistic inference, as disclosed by Dennis L. Barbour et al., 2019 (“Conjoint psychometric field estimation for bilateral audiometry” in Behav. Res. Methods; 2019 June; 51(3): 1271-1285; doi:10.3758/s13428-018-1062-3), which is herewith included by reference.

Variability determination module 306 can be configured to determine the variability range of the estimate based on an uncertainty metric quantifying an uncertainty of the estimate. E.g., the uncertainty metric may be representative of an uncertainty about an accuracy of the hearing characteristics represented in auditory input dataset 312 and/or an uncertainty about an accuracy of the determining of the estimate based on auditory input dataset 312 and/or an uncertainty about an extent of a correction of the estimate which would be required to account for suprathreshold hearing impairment. E.g., a requirement to correct the estimate for suprathreshold hearing impairment may be derived from a semantic user input and/or suprathreshold measurements which may be indicative of the suprathreshold hearing impairment.

In some examples, the uncertainty metric comprises a deviation measure. The deviation measure may be representative of a deviation, or an expected deviation, of one or more estimates of an auditory threshold of an individual, e.g., the user or another individual, from one or more reference datasets containing a more accurate representation of the auditory threshold of the respective individual, e.g., from one or more ground truth datasets. In some examples, the deviation measure comprises one or more of a variance-based metric (e.g., a standard deviation and/or a coefficient of variation), an absolute deviation metric (e.g., a mean absolute deviation) and/or a median absolute deviation, a squared deviation metric (e.g., a mean squared deviation and/or a normalized mean squared deviation), a logarithmic deviation metric (e.g., a mean squared logarithmic deviation and/or a mean absolute logarithmic deviation), or a percentage deviation metric (e.g., a mean absolute percentage deviation).

In some examples, the uncertainty metric comprises a confidence measure. The confidence measure may be representative of a confidence whether the estimate of the auditory threshold is determined correctly. In some examples, the confidence measure may be outputted by a predictive model, e.g., a classification model and/or a GP based model and/or a ML algorithm, by which the estimate is determined. In some examples, the confidence measure comprises one or more of a probability-based metric (e.g., a predicted probability and/or likelihood), a Bayesian-based metric (e.g., a posterior predictive distribution), or a distance-based metric (e.g., a nearest neighbor distance).

Parameter setting module 308 is configured to determine parameter settings 316, 318 each representative of an amplification characteristic of hearing device 201, 261 so as to compensate for a hearing impairment of the user. Generally, a hearing impairment may be reflected by the estimated auditory threshold of the user, or not. E.g., in a case of a mild or moderate or severe hearing loss, the auditory threshold of the user may deviate from an auditory threshold of a person with unimpaired hearing. In a case of a hidden hearing loss, the auditory threshold of the user may substantially correspond to an auditory threshold representative an unimpaired hearing person. The parameter settings comprise at least a first parameter setting 316 and a second parameter setting 318 differing from one another. Parameter settings 316, 318 are determined such that the amplification characteristic of the hearing device is adjusted to the auditory threshold comprised within the variability range of the estimated threshold. To this end, parameter setting module 308 can receive auditory evaluation data 314 from auditory evaluation module 304. E.g., auditory evaluation data 314 may comprise information indicative of the variability range of the estimate.

In some examples, parameter settings 316, 318 may be determined based on a selection of any values from the set of values in which the auditory threshold is variable relative to the estimate within the variability range. In some examples, a first and a second candidate dataset of the auditory threshold may be determined which are each representative of the auditory threshold of the user comprised within the variability range. First parameter setting 316 may then be determined based on the first candidate dataset and second parameter setting 318 may then be determined based on the second candidate dataset. Parameter settings 316, 318 may be determined by a predefined prescription rule. Such a prescription rule may define a mapping from the auditory threshold comprised within the variability range to parameter settings 316, 318. Some well-known examples include the NAL-NL2 prescription rule or the DSL prescription rule, wherein any other prescription rule is conceivable.

Audio output module 309 is configured to initiate an outputting of an audio signal by audio output unit 217 included in hearing device 201 when consecutively applying first and second parameter settings 316, 318 so as to allow the user a comparison in between. In this way, the user can be enabled to choose one of parameter settings 316, 318 according to his preferences. The outputted audio signal may comprise any type of tone or sound, e.g., pure tones, complex tones, noise stimuli, click tones, frequency and/or amplitude modulated tones, speech-like stimuli, swept tones, tone bursts, binaural beats, impulse noise, music, noisy signals, and/or the like. In some examples, the outputted audio signal may be selectable by the user.

The parameter settings provided by parameter setting module 308 comprise first and second parameter settings 316, 318, and may comprise further parameter settings (e.g., third, fourth, etc., parameter settings). The plurality of parameter settings 316, 318 may be consecutively applied in hearing device 201 when outputting an audio signal by audio output unit 217, as initiated by audio output unit 217, so as to allow the user a comparison in between.

In some examples, paired comparisons, or A-B comparisons may be performed. First and second parameter settings 316, 318 may then be consecutively applied, allowing the user to choose one of the pair according to his preferences. Subsequently, another pair 316, 318 may be consecutively applied, which may or may not include the previously chosen parameter settings 316, 318 and at least one other parameter setting, facing the user with at least another alternative. In some examples, comparisons between triplets, quadruplets, etc. of parameter settings 316, 318 may be performed.

In some examples, subsequent pairs 316, 318 of parameter settings may be presented to the user in a round robin procedure. This may imply pairing each option of parameter settings 316, 318 with every other option, at least once, and presenting the pair to the user.

In some examples, subsequent pairs 316, 318 of parameter settings may be presented to the user in an evolutionary algorithm, e.g., a genetic algorithm. In this way, an efficiency of the comparison procedure may be further enhanced by presenting the user with a lower number of alternatives between parameter settings 316, 318. Examples of a genetic algorithm are disclosed in US 2009/279726 A1.

In some examples, after a comparison has been performed by the user, comparison result data may be received from the user, e.g., via a user interface. The comparison result data may be indicative of which of the first and second parameter settings are preferred by the user. The preferred parameter settings may then be stored in memory 202 of hearing device 201.

FIG. 5 illustrates an exemplary configuration 400 in which auditory evaluation module 304 is implemented by a predictive model 405. Predictive model 405 is configured to receive auditory input dataset 312 as an input and to provide auditory evaluation data 314 as an output. In some examples, predictive model 405 can be configured to determine the estimate of the auditory threshold and the variability range of the estimate in an interrelated processing step, e.g., so that the estimate and the variability range are determined in a correlated manner. In some examples, predictive model 405 can be configured to determine the estimate of the auditory threshold and the variability range of the estimate in an subsequent processing steps, e.g., so that the estimate is determined in a previous step and the variability range is determined based on the estimate in a consecutive step.

In some examples, predictive model 405 may include an ML model, e.g., the probabilistic inference model based on GPs disclosed in Dennis L. Barbour et al., 2019, as cited above, and/or the k-means clustering algorithm disclosed in US 2022/0218236 A1, and/or any other ML algorithm.

In some examples, predictive model 405 may be configured to provide auditory evaluation data 314 based on auditory input dataset 312 in multiple processing stages. E.g., in a first processing stage, metadata may be generated from auditory input dataset 312 based on which, in a second processing stage, the estimate of the auditory threshold and/or the variability range is determined. In some examples, the metadata derived from auditory input dataset 312 comprises auditory meta thresholds which may be representative of a provisional estimation of the auditory threshold. E.g., a regression model may be applied to auditory input dataset 312 to derive the meta threshold. The metadata may then be employed by predictive model 405 to determine the estimate of the auditory threshold and/or the variability range based thereon, e.g., based on a ML algorithm and/or by attributing the metadata to one or more prototypes depending on a likelihood and/or similarity. Examples of such a predictive model comprising multiple processing stages for determining the threshold estimate are disclosed in US 2022/0218236 A1.

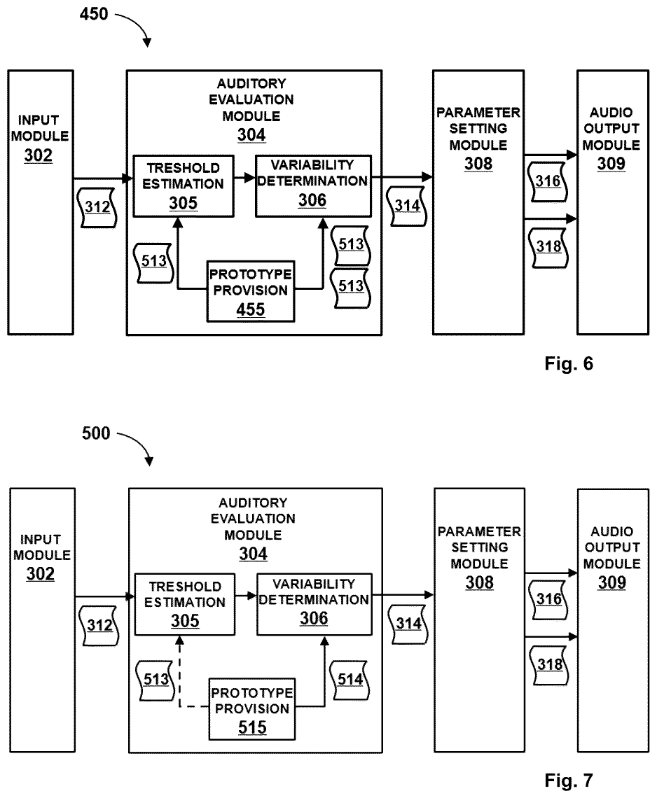

FIG. 6 illustrates an exemplary configuration 450 in which auditory evaluation module 304 includes a prototype provision module 455. Prototype provision module 455 may provide, e.g., store and/or output, one or more prototypes 513 of the auditory threshold. Auditory threshold prototypes 513 each may comprise any predetermined value of the auditory threshold. Auditory threshold prototypes 513 may be accessed by threshold estimation module 305 and/or variability determination module 306. In some examples, prototype provision module 455 may be implemented as a database, e.g., in memory 202, 202. In some examples, prototype provision module 455 may be implemented as a computer program, which may be executed, e.g., by processor 204, 224. In some examples, prototype provision module 455 may be implemented by predictive model 405 so as to output, when determining the estimate of the auditory threshold, one or more of auditory threshold prototypes 513 and/or to output, when determining the variability range of the estimate, two or more of auditory threshold prototypes 513. In some examples, one or more of the outputted auditory threshold prototypes 513 are included in auditory evaluation data 314 provided to parameter setting module 308 to determine parameter settings 316, 318 based thereon.

In some examples, one or more auditory threshold prototypes 513 are ground truth datasets. Ground truth dataset 513 may be regarded as an accurate representation of the auditory threshold of an individual, e.g., the user or any other individual. In some examples, ground truth dataset 513 is representative of a clinical measurement of the auditory threshold, e.g., a pure-tone test, an air conduction measurement, and/or the like. Ground truth dataset 513 may then also be referred to as a clinical auditory threshold (or audiogram), e.g., an air-conduction pure-tone audiogram, of the individual.

Threshold estimation module 305 may be configured to attribute auditory input dataset 312 to one or more of the auditory threshold prototypes 513. In some examples, predictive model 405 may be implemented to determine at least one of auditory threshold prototypes 513 as the estimate. Predictive model 405 may select one or more auditory threshold prototypes 513 depending on a probability or likelihood of a correspondence with auditory input dataset 312. E.g., predictive model 405 may select the auditory threshold prototype 513 that most likely corresponds to, e.g., most closely resembles, auditory input dataset 312 (and/or meta thresholds which may be derived from auditory input dataset 312). In some examples, predictive model 405 may include a ML algorithm, e.g., a classification algorithm, a k-means clustering algorithm, a GP based algorithm and/or the like.

In some examples, when attributing auditory input dataset 312 to one or more of the auditory threshold prototypes 513, predictive model 405 is configured to output a confidence measure whether the attributed auditory threshold prototype 513 is an accurate prediction of the auditory threshold of the user. An accurate prediction may be regarded, e.g., as a prediction matching a ground truth dataset of the user's threshold such as a clinical auditory threshold (or audiogram) of the user.

In some examples, the variability range is determined by variability determination module 306 based on an uncertainty metric comprising the confidence measure. The uncertainty metric may then be representative of a confidence whether the auditory threshold is correctly represented by the estimate corresponding to one or more auditory threshold prototypes 513. In some examples, variability determination module 306 may select two or more auditory threshold prototypes 513 for which the confidence measure indicates the largest probability or likelihood of correspondence with auditory input dataset 312 to be included in the variability range. E.g., a predetermined number of auditory threshold prototypes 513 with the largest value of the confidence measure (e.g., probability or likelihood) may be selected. E.g., auditory threshold prototypes 513 for which the confidence measure exceeds a predetermined threshold may be selected. The selected auditory threshold prototypes 513 may then be included in auditory evaluation data 314 for determining parameter settings 316, 318 based thereon.

FIG. 7 illustrates an exemplary configuration 500 in which auditory evaluation module 304 includes further embodiments of a prototype provision module 515. Prototype provision module 515 may provide, e.g., store and/or output, one or more prototypes 514 of the variability range. Variability range prototypes 514 each may comprise any predetermined value of the variability range. Variability range prototypes 514 may be accessed by variability determination module 306. Prototype provision module 515 may be implemented as a database, computer program, predictive model, ML algorithm, and/or the like. In some examples, one or more of variability range prototypes 514 are included in auditory evaluation data 314 provided to parameter setting module 308 to determine parameter settings 316, 318 based thereon.

In some examples, variability determination module 306 is configured to attribute the estimate of the auditory threshold, as determined by threshold estimation module 305, to one or more variability range prototypes 514. E.g., one or more of variability range prototypes 514 may be attributed to the estimate based on a predetermined selection rule, e.g., a predefined mapping associating different values of the estimate with different variability range prototypes 514, and/or based on a likelihood or probability of correspondence between the estimate and one or more of variability range prototypes 514, which may be determined, e.g., by predictive model 405. The attributed variability range prototype 514 may then be included in auditory evaluation data 314 for determining parameter settings 316, 318 based thereon.

In some examples, one or more variability range prototypes 514 each comprise two or more of auditory threshold prototypes 51, e.g., corresponding to some embodiments described above in conjunction with FIG. 6.

In some examples, prototype provision module 515 is further configured to provide one or more prototypes 513 of the auditory threshold, e.g., as described above in conjunction with FIG. 6. Threshold estimation module 305 may then be configured to attribute auditory input dataset 312 to one or more of the auditory threshold prototypes 513, and variability determination module 306 may then be configured to attribute the respective auditory threshold prototype 513 attributed to auditory input dataset 312 to one or more of variability range prototypes 514. The attributed variability range prototype 514 may then be included in auditory evaluation data 314 for determining parameter settings 316, 318 based thereon.

In some examples, one or more variability range prototypes 514 may be determined based on an uncertainty metric comprising a deviation measure which may be representative of an expected deviation of the estimate from a more accurate and/or less uncertain value of the auditory threshold, e.g., from ground truth data. In some examples, the expected deviation may be represented by a deviation measure determined between one or more historical estimate datasets 511 and one or more reference datasets 512, e.g., ground truth datasets, as further described below.

In some examples, one or more variability range prototypes 514 may be determined based on an uncertainty metric indicative of a correction requirement of the estimate to account for suprathreshold hearing impairment. E.g., indications of a suprathreshold hearing impairment may be derived from a semantic user input and/or suprathreshold measurements which may be included in auditory input dataset 312.

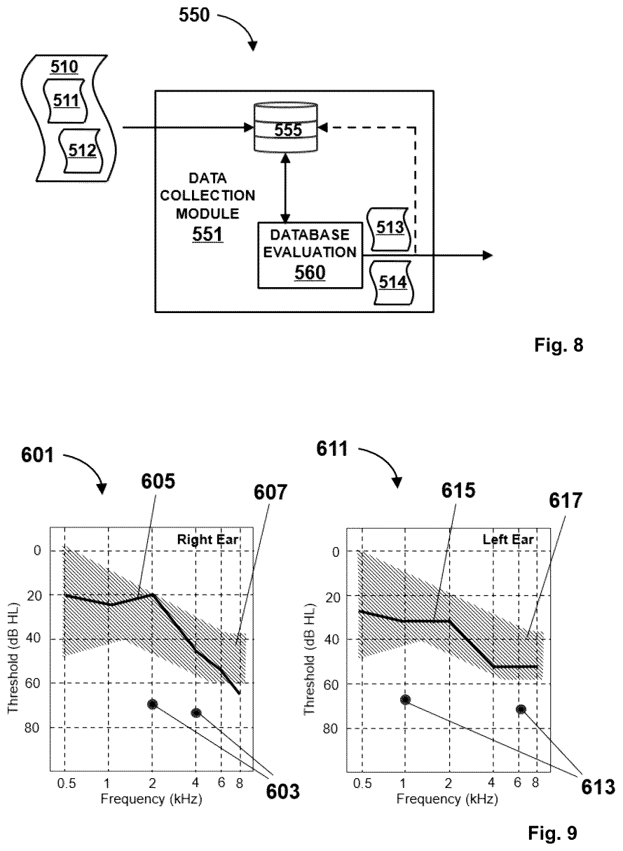

FIG. 8 illustrates an exemplary configuration 550 comprising a data collection module 551 for determining auditory threshold prototypes 513 and/or variability range prototypes 514 based on historical data 510. Data collection module 551 comprises a database 555 for collecting historical data 510, and a database evaluation module 560 for evaluating the collected data 511.

Historical data 510 may be collected from a plurality of different individuals, e.g., the user and/or other individuals. For each individual, historical data 510 may comprise an historical estimate dataset 511 representative of an estimate of the auditory threshold of the respective individual. In some examples, historical estimate dataset 511 may have been determined by auditory evaluation module 304, e.g., by threshold estimation module 305 and/or predictive model 405, as described above. In other examples, historical estimate dataset 511 may have been determined in other ways. In some examples, historical estimate dataset 511 may have been determined based on an historical auditory input dataset representative of one or more hearing characteristics of the individual. E.g., the historical auditory input dataset may comprise one or more datasets corresponding to one or more datasets included in auditory input dataset 312 representative of user 233, and/or other types of datasets representative of the individual's hearing characteristics.

Historical data 510 may further comprise a reference dataset 512 representative of the auditory threshold of the respective individual. Reference dataset 512 may have been determined with a higher accuracy and/or lower uncertainty as compared to historical estimate dataset 511. In some examples, reference dataset 512 is obtained in a clinical measurement of the auditory threshold of the respective individual, e.g., in the form of a clinical audiogram. In some examples, reference dataset 512 is a ground truth dataset.

In some examples, reference dataset 512 may be representative of a correction of historical estimate dataset 511 required to account for suprathreshold hearing impairment. Reference dataset 512 may then represent an estimate of an effective auditory threshold of the individual in which the suprathreshold hearing impairment is reflected and/or accounted for. The effective auditory threshold may then be regarded as an effective hearing impairment of the individual.

Historical data 510 may be collected in database 555 over time from the different individuals, each having an individual hearing impairment or unimpaired hearing characteristic. Database evaluation module 560 may access historical data 510 from database 555 to determine auditory threshold prototypes 513 and/or variability range prototypes 514 based thereon. In some examples, one or more auditory threshold prototypes 513 may be based on one or more reference datasets 512. In some examples, one or more variability range prototypes 514 may be based on an evaluation of one or more historical estimate datasets 511 and/or one or more reference datasets 512. Database evaluation module 560 may output auditory threshold prototypes 513 and/or variability range prototypes 514 and/or store prototypes 513, 514 in database 555.

In some examples, a deviation measure between one or more historical estimate datasets 511 and one or more reference datasets 512 may be determined. The deviation measure may be employed as an uncertainty metric for determining a variability range, which may then be provided as one or more variability range prototypes 514. In some examples, when reference dataset 512 represents a correction of historical estimate dataset 511 to account for suprathreshold hearing impairment, the variability range prototypes 514 may represent an expected correction of the estimate required to account for suprathreshold hearing impairment.

In some examples, at least part of historical data 510 and/or auditory threshold prototypes 513 and/or variability range prototypes 514 may be used as training data to train a ML algorithm for predicting a threshold estimate of the user and/or a variability range of the estimate. E.g., predictive model 405 may include such a ML algorithm. In some examples, auditory threshold prototypes 513 and/or variability range prototypes 514 may be stored in a memory 202, 222 of system 200 so as to be accessible by prototype provision module 515.

FIG. 9 illustrates exemplary graphs 601, 611 of a frequency-dependent auditory threshold of different ears of a user. Graph 601 relates to the right ear of the user. Graph 611 relates to the left ear of the user. The frequency is indicated in units of kHz (Kilohertz) on an axis of abscissas. Corresponding auditory threshold values are indicated in units of dB HL (hearing loss (HL) in decibels (dB)) on an axis of ordinates.

An auditory measurement dataset 603, 613 is indicated in graphs 601, 611 by circular bullet symbols. Auditory input dataset 312 may comprise auditory measurement dataset 603, 613. The auditory measurement dataset is representative of measured values 603 of an auditory threshold of the right ear and measured values 613 of an auditory threshold of the left ear which are acquired in an auditory measurement procedure. Measured auditory threshold values 603, 613 may represent a reaction of the user to auditory stimuli presented to the user at different frequencies in the auditory measurement procedure. In some examples, measured auditory thresholds 603, 613 may be acquired in an auditory measurement procedure of a lower accuracy and/or a higher uncertainty as compared to a measurement performed by a hearing care professional in a clinic such as a clinical air-conduction audiogram. In some examples, measured auditory thresholds 603, 613 may be acquired in a self-administered hearing test performed by the user, for instance according to the measurement procedure described in US 2022/0218236 A1. In some examples, further data, e.g., a suprathreshold measurement dataset and/or a semantic input dataset, may be obtained from the user in addition to auditory measurement dataset 603, 613 to be included in auditory input dataset 312.

An estimate 605, 615 of a frequency-dependent auditory threshold of the user is indicated in graphs 601, 611 by solid curves for the right and left ear respectively. The estimate is determined based on the auditory input dataset including measured auditory threshold values 603, 613. Thus, an accuracy of the auditory threshold, as represented by estimate 605, 615, can be improved relative to measured values 603, 613 and/or an uncertainty inherent to the measurement of values 603, 613 can be reduced by estimate 605, 615. In some examples, estimate 605, 615 is determined by attributing auditory measurement dataset 603, 613 to one of prototypes 513. In some examples, estimate 605, 615 is determined in a predictive model in which measured auditory threshold values 603, 613 are inputted. In some examples, estimate 605, 615 is determined in a regression and/or classification model, e.g., as described in US 2022/0218236 A1. In some examples, estimate 605, 615 is determined in a model based on GPs as disclosed in Dennis L. Barbour et al., 2019.

In the illustrated example, estimate 605, 615 is provided as an estimate of an audiogram which could also be obtainable in a clinical measurement, e.g., a pure-tone measurement of the auditory threshold. Estimate 605, 615 may thus be indicative of a clinically measurable hearing loss, e.g., a mild, moderate, or severe hearing loss, when estimate 605, 615 deviated from the auditory threshold of a normally hearing person. In other examples, estimate 605, 615 may be representative of an effective hearing impairment, e.g., a suprathreshold hearing impairment. In this case, the effective auditory threshold represented by estimate 605, 615 may be adapted so as to account for the suprathreshold hearing impairment. In those cases, the auditory threshold may be indicated in units of dB (decibels) on the axis of ordinates.

A variability range 607, 617 of estimate 605, 615 of the auditory threshold is indicated in graphs 601, 611 by dashed areas for the right and left ear respectively. Variability range 607, 617 defines a set of values in which the auditory threshold is variable relative to estimate 605, 615. In the illustrated example, the set of values is implemented as a continuous interval of threshold values (i.e. relative to the axis of ordinates), wherein the interval size depends on a frequency of the auditory threshold, e.g., varies with the frequency. In other examples, a size of the interval may be constant with varying frequency of the auditory threshold. In still other examples, variability range 607, 617 may comprise a plurality of intervals in which the auditory threshold is variable.

Variability range 607, 617 can be determined based on an uncertainty metric representative of an uncertainty of estimate 605, 615. In some examples, the variability range may be representative of, e.g., correspond to, the uncertainty metric and/or the variability range may be scaled depending on the uncertainty metric. To illustrate, when the uncertainty metric is indicative of a smaller value of an uncertainty of the estimate, variability range 607, 617 (e.g., the interval of threshold values) may be determined to be smaller as compared to when the uncertainty metric is indicative of a larger value of uncertainty of the estimate. In some examples, the uncertainty metric may depend on a frequency of the estimate, which may then be reflected in the variability range also depending on the frequency of the auditory threshold (e.g., the frequency dependent interval 607, 617). In some examples, the uncertainty metric may be a value representative of an uncertainty of the integral estimate (e.g., over a whole frequency range of the estimate and/or independent from the frequency).

In some examples, variability range 607, 617 may be determined in conjunction with estimate 605, 615. For instance, predictive model 405 may be configured to output variability range 607, 617 in conjunction with estimate 605, 615. To illustrate, an ML model, such as a model based on GPs described by Dennis L. Barbour et al., 2019, may output estimate 605, 615 in conjunction with the uncertainty metric in the form of an error interval and/or a confidence measure, e.g., a probability, whether the estimate has been correctly determined.

In some examples, variability range 607, 617 may be determined based on estimate 605, 615. For instance, in a first step, estimate 605, 615 may be determined, and, in a second step, variability range 607, 617 may be determined depending on estimate 605, 615.

In some examples, variability range 607, 617 may be determined by attributing estimate 605, 615 to one or more of variability range prototypes 514, as described above. For instance, when estimate 605, 615 is determined by attributing auditory measurement dataset 603, 613 to one or more of auditory threshold prototypes 513, one or more of variability range prototypes 514 may be selected simultaneously or subsequently depending on the attributed auditory threshold prototype 513. E.g., a predefined selection rule and/or other relationship may be applied which defines a mapping from one or more of of auditory threshold prototypes 513 to one or more of variability range prototypes 514. Such a mapping may further depend on additional information, e.g., age, gender, type of hearing loss, etc. of the user, which may be included in a questionnaire response dataset of the user.

Parameter setting module 308 can be configured to determine parameter settings 316, 318 such that the amplification characteristic of hearing device 201 is adjusted to the auditory threshold comprised within variability range 607, 617. In some examples, two or more candidate datasets representative of the auditory threshold of the user may be determined within variability range 607, 617. The candidate datasets may represent any values of the auditory threshold lying within variability range 607, 617. E.g., one or more candidate datasets may be randomly selected within variability range 607, 617, and/or one or more candidate datasets may be selected from variability range 607, 617 by a predefined selection rule, e.g., in a round robin procedure or selected according to an evolutionary algorithm. Parameter settings 316, 318 may then be determined from the candidate datasets by a predefined prescription rule, e.g., NAL-NL2 or the like. E.g., first and second parameter settings 316, 318 may be determined from a first and second candidate dataset, which may be selected from any plurality of candidate datasets. In some other examples, parameter settings 316, 318 may be directly determined from variability range 607, 617 by a predefined prescription rule defining a predefined mapping of variability range 607, 617 to parameter settings 316, 318.

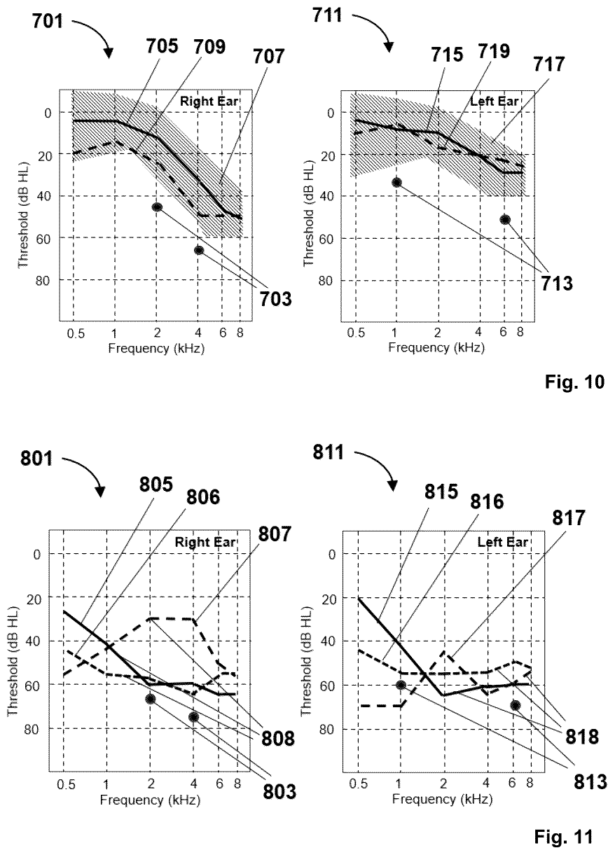

FIG. 10 illustrates exemplary graphs 701, 711 of a frequency-dependent auditory threshold of an individual, e.g., a hearing-impaired person different from the user, or the user. Graphs 701, 711 relate to the individual's right and left ear, respectively. Graphs 701, 711 display respective measured auditory threshold values 703, 713 (e.g., acquired corresponding to measured values 603, 613 described above), a respective estimate 705, 715 of an auditory threshold of the individual (e.g., determined corresponding to estimate 605, 615 described above), and a respective variability range 707, 717 of estimate 705, 715.

A reference dataset 709, 719 is indicated in graphs 701, 711 by dashed curves for the right and left ear respectively. Reference dataset 709, 719 is representative of the auditory threshold of the individual determined at a higher accuracy and/or with a lower uncertainty as compared to estimate 705, 715. In some examples, reference dataset 709, 719 may be acquired in a high accuracy measurement of the auditory threshold, e.g., in a clinical measurement such as a measurement based on air-conduction audiometry. Reference dataset 709, 719 may also be representative of a ground truth dataset which may be regarded as an accurate representation of the auditory threshold.

A variability range 707, 717 of estimate 705, 715 of the auditory threshold is indicated in graphs 701, 711 by dashed areas for the right and left ear respectively. An uncertainty metric, based on which variability range 707, 717 is determined, comprises a deviation measure representative of a deviation between estimate 705, 715 and reference dataset 709, 719. In some examples, the deviation measure is implemented as an error interval representative of an error of estimate 705, 715 relative to reference dataset 709, 719. In some examples, the deviation measure comprises a variance-based metric, e.g., a standard deviation, and/or a squared deviation metric and/or an absolute deviation metric, e.g., a root mean squared deviation.

In some examples, estimate 705, 715 and corresponding reference dataset 709, 719 may be included in historical data 510 which may be collected for a plurality of different individuals in database 555 so as to determine auditory threshold prototypes 513 and/or variability range prototypes 514 based thereon. Estimate 705, 715 may be an example of historical estimate dataset 511, and reference dataset 709, 719 may be an example of reference dataset 512, as described above in conjunction with FIG. 8. Measured auditory threshold values 703, 713 may represent an historical auditory input dataset representative of one or more hearing characteristics of the individual based on which historical estimate dataset 511 can be determined.

In some examples, as described above in conjunction with FIGS. 6 and 7, estimate 705, 715 and/or reference dataset 709, 719 may be provided as one of auditory threshold prototypes 513, e.g., in the form of a ground truth dataset. In some examples, variability range 707, 717 may be provided as one of variability range prototypes 514. In some examples, the variability range prototype 707, 717 may be attributed to the auditory threshold prototype 513 which may be represented by estimate 705, 715.

FIG. 11 illustrates exemplary graphs 801, 811 of a frequency-dependent auditory threshold of the user for the right and left ear. Graphs 801, 811 display respective measured auditory threshold values 803, 813 (e.g., acquired corresponding to measured values 603, 613, 703, 713 described above), a respective estimate 805, 815 of an auditory threshold of the individual (e.g., determined corresponding to estimate 605, 615, 705, 715 described above), and a respective variability range 808, 818 of estimate 805, 815.

Variability range 808 of the right ear estimate 805 comprises a set of values including a plurality of subsets 805, 806, 807 of discrete values of the auditory threshold. Correspondingly, variability range 818 of the left ear estimate 815 comprises a plurality of subsets 815, 816, 817 of discrete values of the auditory threshold. The discrete values in each subset 805, 806, 807, 815, 816, 817 of variability range 808, 818 depend on a frequency of the auditory threshold. In some examples, the discrete values in each subset 805, 806, 807, 815, 816, 817 may be defined by an injective mapping from different frequencies of the auditory threshold to different values of the auditory threshold. In some examples, each subset 805, 806, 807, 815, 816, 817 may be a respective audiogram. In some examples, the discrete threshold values of each subset 805, 806, 807, 815, 816, 817 correspond to a prototype 513 of the auditory threshold. Variability range 808, 818 may thus be defined by two or more of auditory threshold prototypes 513.

In some examples, estimate 805, 815 may be determined by predictive model 405, which may attribute the auditory measurement dataset 803, 813 to one or more of auditory threshold prototypes 513. The model may further determine a confidence measure associated with the attributed protype, e.g., a probability or likelihood whether the prototype is correctly attributed. The model may determine estimate 805, 815 depending on the confidence measure, e.g., by selecting the prototype 513 that is most likely correctly attributed.

In some examples, variability range 808, 818 may also be determined by predictive model 405 based on the confidence measure as the uncertainty metric. In some examples, variability range 808, 818 may be determined based on a predefined threshold of the confidence measure. E.g., variability range 808, 818 may be determined such that it comprises the auditory threshold prototypes 513 for which the confidence measure exceeds the threshold. In some examples, variability range 808, 818 may be determined based on a predefined number of prototypes 513 to be contained in variability range 808, 818. E.g., variability range 808, 818 may be determined such that it comprises the auditory threshold prototypes 513 of that number with the largest likelihood.

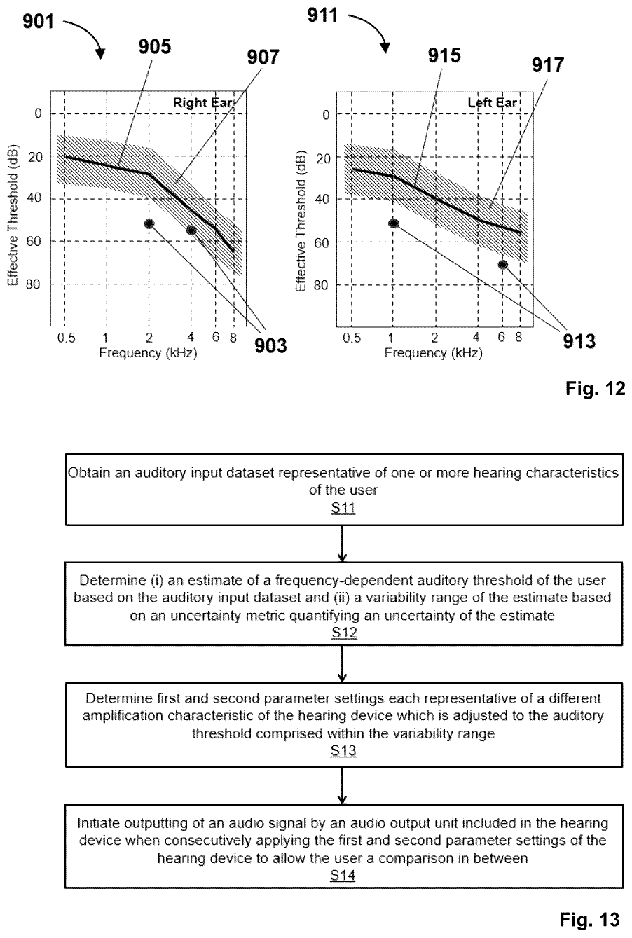

FIG. 12 illustrates exemplary graphs 901, 911 of an effective auditory threshold of the user for the right and left ear. Graphs 901, 911 display respective measured auditory threshold values 903, 913 (e.g., acquired corresponding to measured values 603, 613, 703, 713, 803, 813 described above). In the illustrated example, an estimate 905, 915 of an auditory threshold of the individual represents an estimate of an effective hearing impairment. The effective hearing impairment is displayed in units of dB. In some examples, the effective hearing impairment relates to a suprathreshold hearing impairment, e.g., a subclinical and/or hidden hearing loss. Estimate 905, 915 of the effective auditory threshold may then be representative of the auditory threshold of the user adapted to the suprathreshold hearing impairment.

In some examples, additional indications about the suprathreshold hearing impairment may be included in auditory input dataset 312, e.g., in the form of a semantic user input and/or suprathreshold measurements. Estimate 905, 915 may then be determined based on the additional indications about the suprathreshold hearing impairment in input dataset 312 in addition to measured threshold values 903, 913. Estimate 905, 915 may be determined in a predictive model, e.g., corresponding to estimate 605, 615 described above. This may comprise attributing input dataset 312 to one of prototypes 513, wherein prototypes 513 may then be provided as prototypes of the effective hearing impairment and/or wherein the attributed prototype 513 is adjusted after the attribution so as to account for the suprathreshold hearing impairment.

A variability range 907, 917 of estimate 905, 915 of the effective auditory threshold is indicated in graphs 901, 911 by dashed areas for the right and left ear respectively. In the illustrated example, the set of values defined by variability range 907, 917 is implemented as a continuous interval of threshold values having a constant interval size at different frequencies. Variability range 907, 917 may be determined corresponding to any methods and/or principles described above. In some examples, variability range 907, 917 may be provided with a frequency dependent interval size, e.g., corresponding to variability range 607, 617, 707, 717 described above. In some examples, variability range 907, 917 may be provided as a plurality of subsets each comprising one or more discrete values of the auditory threshold, e.g., corresponding to variability range 807, 817. E.g., the discrete threshold values of each subset may correspond to a prototype 513 of the effective auditory threshold to account for the suprathreshold hearing impairment.

In some examples, the uncertainty metric based on which variability range 907, 917 is determined comprises a correction requirement, e.g., a correction specification and/or a correction value range, representative of an estimated correction of estimate 905, 915 required to account for the suprathreshold hearing impairment. In some examples, the required correction of estimate 905, 915 can be determined from auditory input dataset 312. E.g., suprathreshold measurements and/or semantic user input may be included in auditory input dataset 312 from which a presence and/or an extent of the suprathreshold hearing impairment may be derived. In some examples, variability range 907, 917 may be determined from historical data 510 collected in database 555. E.g., determining variability range 907, 917 may be based on a correction of historical estimate datasets 511 which has been previously required to account for the suprathreshold hearing impairment. In particular, one or more of prototypes 514 of the variability range be determined in this way.

FIG. 13 illustrates a block flow diagram for an exemplary method of fitting a hearing device to a user. The method may be executed, e.g., by processor 104 of system 100 and/or processor 204, 224 of system 200. The method comprises an auditory input operation at S11 of obtaining an auditory input dataset representative of one or more hearing characteristics of the user. The method further comprises an auditory threshold estimation operation at S12 of determining (i) an estimate of a frequency-dependent auditory threshold based on the auditory input dataset and (ii) a variability range, the variability range defining a set of values in which the auditory threshold is variable relative to the estimate, wherein the variability range is determined based on an uncertainty metric representative of, e.g., quantifying, an uncertainty of the estimate. The method further comprises a parameter setting operation at S13 of determining first and second parameter settings each representative of a different amplification characteristic of the hearing device so as to compensate for a hearing impairment, e.g., a hearing loss associated with the auditory threshold of the user, wherein the first and second parameter settings are determined such that the amplification characteristic of the hearing device is adjusted to the auditory threshold comprised within the variability range. The method further comprises an audio outputting operation at S14 of initiating an outputting of an audio signal by an audio output unit included in the hearing device when consecutively applying the first and second parameter settings of the hearing device so as to allow the user a comparison in between. In some examples, the method further comprises, e.g., after audio outputting operation S14, receiving, e.g., via a user interface, comparison result data indicative of which of the first and second parameter settings are preferred by the user, and, storing the preferred parameter settings in a memory of the hearing device.

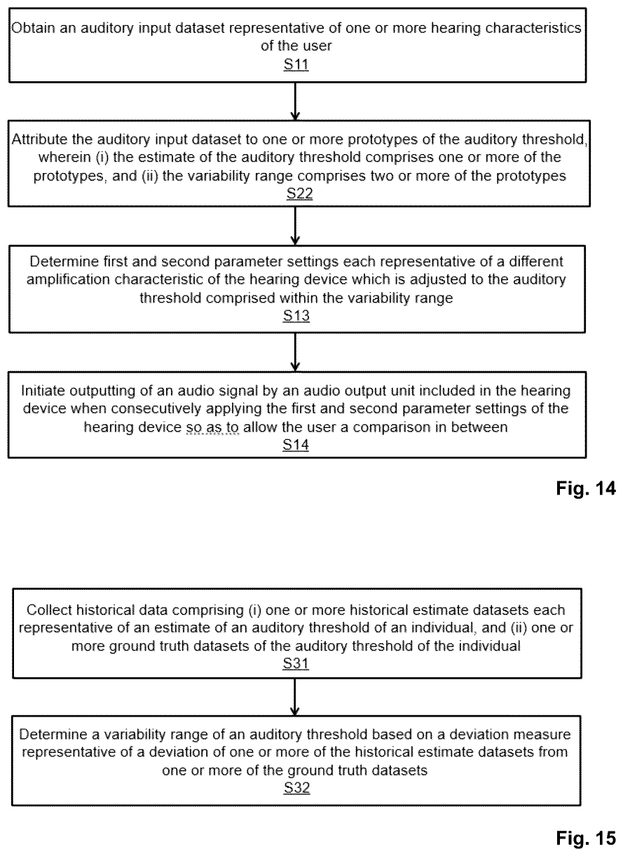

FIG. 14 illustrates another block flow diagram for an exemplary method of fitting a hearing device to a user. Subsequent to auditory input operation at S11, an auditory threshold estimation operation at S22 comprises attributing the auditory input dataset to one or more prototypes of the auditory threshold, wherein (i) the estimate of the auditory threshold comprises one or more of the prototypes, and (ii) the variability range comprises two or more of the prototypes. Subsequently, parameter setting operation S13 and audio outputting operation S14 are performed.

FIG. 15 illustrates a block flow diagram for determining a variability range of an auditory threshold based on historical data. The method comprises a data collection operation at S31 of collecting historical data comprising (i) one or more historical estimate datasets each representative of an of an estimate of an auditory threshold of an individual, and ground truth datasets each representative of an auditory threshold of an individual and (ii) one or more a reference datasets, e.g., ground truth datasets, representative of the auditory threshold of the respective individual. E.g., the historical data may be collected in database 555. The method further comprises a data evaluation operation at S32 of determining a variability range of an auditory threshold based on a deviation measure as an uncertainty metric, wherein the deviation measure is representative of a deviation of one or more of the historical estimate datasets from one or more of the ground truth datasets.

While the principles of the disclosure have been described above in connection with specific devices, systems and methods, it is to be clearly understood that this description is made only by way of example and not as limitation on the scope of the invention. The above-described preferred embodiments are intended to illustrate the principles of the invention, but not to limit the scope of the invention. Various other embodiments and modifications to those preferred embodiments may be made by those skilled in the art without departing from the scope of the present invention that is solely defined by the claims. In the claims, the word “comprising” does not exclude other elements or steps, and the indefinite article “a” or “an” does not exclude a plurality. A single processor or controller or other unit may fulfil the functions of several items recited in the claims. The mere fact that certain measures are recited in mutually different dependent claims does not indicate that a combination of these measures cannot be used to advantage. Any reference signs in the claims should not be construed as limiting the scope.

1. A method of fitting a hearing device to a user, the method comprising:
obtaining an auditory input dataset representative of one or more hearing characteristics of the user;
determining an estimate of an auditory threshold based on the auditory input dataset;
determining first and second parameter settings each representative of a different amplification characteristic of the hearing device so as to compensate for a hearing impairment of the user; and
initiating an outputting of an audio signal by an audio output unit included in the hearing device when consecutively applying the first and second parameter settings of the hearing device so as to allow the user a comparison in between,
wherein the method further comprises:
determining a variability range of the estimate, the variability range defining a set of values in which the auditory threshold is variable relative to the estimate, wherein the variability range is determined based on an uncertainty metric representative of an uncertainty of the estimate, and wherein the first and second parameter settings are determined such that the amplification characteristic of the hearing device is adjusted to the auditory threshold comprised within the variability range.

2. The method of claim 1, wherein the uncertainty metric is representative of:
an expected deviation of the estimate from ground truth data regarded as an accurate representation of the auditory threshold; and/or
a confidence whether the auditory threshold is correctly represented by the estimate output by a predictive model; and/or
an expected correction of the estimate required to account for suprathreshold hearing impairment.

3. The method of claim 1, wherein said set of values comprises one or more of:
at least one interval having a size depending on a frequency of the auditory threshold;
at least one interval with a constant size at different frequencies of the auditory threshold; or
a plurality of subsets of discrete values of the auditory threshold.

4. The method of claim 1, further comprising:
providing a plurality of prototypes of the auditory threshold,
wherein said determining of the estimate of the auditory threshold and/or said determining of the variability range comprises
attributing the auditory input dataset to one or more of the auditory threshold prototypes.

5. The method of claim 4, wherein the variability range is determined such that said set of values comprises two or more of the attributed auditory threshold prototypes.

6. The method of claim 4, wherein the uncertainty metric is representative of an uncertainty whether the auditory input dataset is correctly attributed to the auditory threshold prototype.

7. The method of claim 6, wherein the attributing the auditory input dataset to the one or more of the auditory threshold prototypes comprises:
inputting the auditory input dataset in a model configured to output one or more of the auditory threshold prototypes attributed to the auditory input dataset and the uncertainty metric associated with the respective attributed auditory threshold prototype and/or the variability range based on the uncertainty metric associated with the respective attributed auditory threshold prototype.

8. The method of claim 1, wherein said determining of the estimate of the auditory threshold comprises
inputting the auditory input dataset in a machine learning algorithm configured to predict the estimate of the auditory threshold, and a confidence measure indicative of a confidence of the prediction, wherein the uncertainty metric comprises the confidence measure.

9. The method of claim 1, further comprising:
providing a plurality of prototypes of the variability range,
wherein said determining of the variability range comprises attributing the estimate of the auditory threshold to at least one of said variability range prototypes.

10. The method of claim 1, further comprising:
collecting, in a database, historical data associated with different individuals, wherein the historical data comprises:
a historical estimate dataset representative of an estimate of the auditory threshold of the respective individual; and
a reference dataset representative of the auditory threshold of the respective individual which has been determined with a higher accuracy and/or lower uncertainty as compared to the historical estimate dataset; and
determining a deviation measure representative of a deviation of the historical estimate dataset from the reference dataset for one or more of said individuals, wherein the uncertainty metric comprises the deviation measure.

11. The method of claim 10, wherein the reference dataset is a ground truth dataset which is regarded as an accurate representation of the auditory threshold of the individual.

12. The method of claim 10, further comprising determining one or more of the variability range prototypes based on the deviation measure.

13. The method of claim 1, further comprising determining two or more candidate datasets representative of the auditory threshold of the user within the variability range, wherein the first and/or second parameter settings are determined from the candidate datasets by a predefined prescription rule.

14. The method of claim 13, wherein the first and/or second parameter settings are determined from three or more candidate datasets by one or more of:
a round robin procedure; or
a selection based on an evolutionary algorithm.

15. A system for fitting a hearing device to a user, the system comprising a processor configured to perform the method according to claim 1.
